(19) United States
(12) Patent Application Publication
(10) Pub. No.: US 2011/0004370 A1
(43) Pub. Date: Jan. 6, 2011

(54) STOP HISTORY DATA ACCUMULATION SYSTEM, ACCUMULATION METHOD, AND ACCUMULATION PROGRAM

(75) Inventors: Kenji Nagase, Okazaki (JP); Hiroki Ishikawa, Anjo (JP)

Correspondence Address: OLIFF & BERRIDGE, PLC, P.O. BOX 320850, ALEXANDRIA, VA, 22320-4850, US

(73) Assignee: Aisin AW Co., Ltd., Anjo-shi (JP)

(21) Appl. No.: 12/919,348

(22) PCT Filed: Mar. 17, 2009
(86) PCT No.: PCT/JP2009/001177

§ 371 Date: Aug. 25, 2010

(30) Foreign Application Priority Data
Mar. 28, 2008 (JP) 2008-086983
Mar. 28, 2008 (JP) 2008-086995

(51) Int. Cl. G06F 7/00

(52) U.S. Cl. 701/35

(57) ABSTRACT

State information indicating an state of a vehicle is obtained. Based on the state information, group information is obtained that is formed from first stop information including a first stop position at which the vehicle stopped and formed from second stop information including a second stop position at which the vehicle stopped subsequent to the first stop position. Based on the group information, identification information for identifying a road zone including the second stop position is associated with the first stop position and accumulated.

### TECHNICAL FIELD

The present invention relates to a stop history data accumulation system, an accumulation method, and an accumulation program that accumulate a stop history of a vehicle.

### BACKGROUND ART

Known art uses information (signal information) that indicates a timing at which a traffic signal in a systematic signal zone is lit, and provides guidance for a vehicle speed at which a vehicle can advance through the zone without stopping at the traffic signal.

Patent Citation 1: Japanese Patent Application Publication No. JP-A-2005-115638

### DISCLOSURE OF INVENTION

### Technical Problem

In Japanese Patent Application Publication No. JP-A-2005-115638, based on information indicating an installation position of a traffic signal in a systematic signal zone and a timing at which the traffic signal is lit, guidance is provided regarding a vehicle speed at which a vehicle can travel without stopping at the traffic signal in the systematic signal zone. However, in cases where during actual travel a stop is caused by a stop-inducing object (such as a signal) that makes the vehicle to stop, whether the vehicle stops at a subsequent stop-inducing object, for example, depends on a stop position of the vehicle with respect to the initial stop-inducing object. The signal information described in Japanese Patent Application Publication No. JP-A-2005-115638 does not consider the relationship between the stop-inducing object and the stop position of the vehicle with respect to the stop-inducing object during this type of actual travel. As a consequence, guidance pertaining to a traffic signal cannot be suitably performed with the signal information of Japanese Patent Application Publication No. JP-A-2005-115638.

The present invention was devised in light of the foregoing problem, and it is an object of the present invention to provide art that accumulates stop history data associated with a stop position of a vehicle and pertaining to a zone in which a plurality of stop-inducing objects exists.

### Technical Solution

In order to achieve the above object, according to the present invention, group information is obtained that is formed from first stop information including a first stop position at which a vehicle stopped and formed from second stop information including a second stop position at which the vehicle stopped subsequent to the first stop position. Based on the group information, identification information for identifying a road zone including the second stop position is associated with the first stop position and accumulated. According to this structure, the accumulated information as described above can be referenced to identify a second stop position where the vehicle stopped next after stopping at the first stop position.

An state information acquisition unit is not limited provided that the state information acquisition unit is capable of obtaining state information indicating an state of a vehicle. The state information includes at least information specifying the current position of the vehicle and information for determining whether the vehicle has stopped. Various known sensors and cameras may be adopted in order to obtain such information. For example, a structure that obtains the current position of the vehicle using a sensor or a camera, a structure that identifies a position using a GPS signal or a trajectory on a map, and a structure that obtains information specifying a vehicle speed using a vehicle speed sensor may be employed.

A stop history acquisition unit, based on the state information, obtains group information formed from first stop information that includes a first stop position at which the vehicle stopped, and formed from second stop information that includes a second stop position at which the vehicle stopped subsequent to the first stop position. The first stop information is information that includes at least the first stop position, and the second stop information is information that includes at least the second stop position. The first stop information and the second stop information corresponding to the two consecutive stops made are called one set of group information here.

A stop history accumulation unit, based on the group information, accumulates identification information, which is used for identifying a road zone including the second stop position, by associating with the first stop position. The identification information is not limited provided that use of the identification information enables identification of a road zone including the second stop position; for example, the identification information may be the location (coordinates) of the second stop position itself, information specifying a link that includes the second stop position, and information specifying nodes that are start and finish points of the link. Furthermore, information specifying nodes that are start and finish points of a road zone (a zone forming two or more links) whose two end points are signalized intersections and which includes the second stop position may be used.

According to the present invention, the second stop information may include information specifying a second signalized intersection nearest to the vehicle that is ahead of the vehicle at the second stop position. In such case, the stop history accumulation unit may accumulate the information specifying the second signalized intersection as the identification information, by associating with the first stop position. According to this structure, information specifying the nearest signalized intersection in front of the second stop position, based on the travel direction of the vehicle, can be associated with the first stop position and accumulated. Therefore, after the vehicle stops at a certain position, it is possible to identify where the vehicle will stop next due to which signal, by referring to such associated and accumulated information. The information specifying the second signalized intersection is not limited provided that the information is capable of identifying the second signalized intersection. For example, a node identifier corresponding to the signalized intersection, a position of the signalized intersection, and the like are conceivable.

According to the present invention, the first stop information may include information specifying a first signalized intersection nearest to the vehicle that is ahead of the vehicle at the first stop position. In such case, the stop history accumulation unit may accumulate the information specifying the second signalized intersection, by associating with the first stop position and the information specifying the first signalized intersection. According to this structure, it is possible to accumulate the first stop position and the information specifying the first signalized intersection, by associating with the information specifying the second signalized intersection. Therefore, after the vehicle stops at a certain position due to a certain signal, it is possible to identify where the vehicle will stop next due to which signal, by referring to such associated and accumulated information. The information specifying the first signalized intersection is not limited provided that the information is capable of identifying the nearest signalized intersection from the first stop position that is also in front of the first stop position, based on the travel direction of the vehicle. For example, the information may be an identifier of a node corresponding to the signalized intersection, or the position of the signalized intersection itself. Note that by using such information specifying the first signalized intersection, the stop history accumulation unit may derive a distance between the first signalized intersection and the first stop position, associate the distance and the first signalized intersection with information specifying the second signalized intersection, and accumulate the associated information. With regard to the second stop position as well, the stop history accumulation unit may derive a distance from the second signalized intersection to the second stop position, and accumulate the distance and information specifying the second signalized intersection.

In the present invention, the first stop information may include a date and time at which the vehicle stopped at the first stop position, and in such case, the stop history accumulation unit may further accumulate the identification information, by associating with a time period to which the date and time belong. According to this structure, identification information that is associated with a date and time and the first stop position, or associated with the date and time, the first stop position, and information specifying the first signalized intersection, can be accumulated. Therefore, by referring to such associated and accumulated information, it is possible to obtain identification information that corresponds to a season or a time period within one day.

Furthermore, in the present invention, the stop history acquisition unit may obtain information specifying a passed signalized intersection that the vehicle passed without stopping between the first stop position and the second stop position. In such case, the stop history accumulation unit may accumulate information specifying passed intersections, by associating with the first stop position. According to this structure, for example, it is possible to accumulate the identification information and the number of passed signalized intersections. Therefore, after the vehicle stops at a certain position, it is possible to identify how many signalized intersections the vehicle passed before stopping again, by referring to such accumulated information.

According to the present invention, when a plurality of sets of group information is obtained in which the first stop position is a predetermined position, the stop history accumulation unit may accumulate representative identification information among the identification information for the respective sets of group information, by associating with the predetermined position. According to this structure, after collecting the multiple sets of group information, statistical processing is used to derive representative identification information therefrom. The derived representative identification information can then be associated with the first stop position and accumulated. As a consequence, when a vehicle stops at a predetermined position, it is possible to identify at which position the vehicle is highly likely to stop next by referring to such accumulated information. Here, a mean value, a mode value, a median value or the like may be assumed as the representative identification information, for example.

Note that the procedure as described in the present invention is also applicable as a program or a method that performs such processing, wherein group information is obtained that is formed from first stop information including a first stop position at which a vehicle stopped and formed from second stop information including a second stop position at which the vehicle stopped subsequent to the first stop position; and based on the group information, identification information for identifying a road zone including the second stop position is associated with the first stop position and accumulated. The above-described data accumulation system, method, and program include various forms, and may be realized as an individual device, realized through parts used in common with respective components provided in the vehicle, or realized through cooperation with respective components not installed in the vehicle. Furthermore, modifications can be made as appropriate such as using software for a portion or using hardware for a portion. The invention is also achieved as a recording medium of a program that controls the stop history data accumulation system. The recording medium of such software may naturally be a magnetic recording medium or a magneto-optic recording medium, and the same holds for any recording medium developed in the future.

### BRIEF DESCRIPTION OF THE DRAWINGS

FIG. 1 is a block diagram of a stop history data accumulation system in accordance with a first embodiment of the present invention;

FIG. 2 is a flowchart showing stop history acquisition processing in accordance with the first embodiment of the present invention;

FIG. 3 is a flowchart showing stop history accumulation processing in accordance with the first embodiment of the present invention;

FIG. 4 is a schematic drawing showing a data structure of a stop history database in accordance with the first embodiment of the present invention;

FIG. 5 is a schematic drawing showing an example of a first stop position and a second stop position in accordance with the first embodiment of the present invention;

FIG. 6 is a schematic drawing showing an example of the first stop position and the second stop position in accordance with the first embodiment of the present invention;

FIG. 7 is a block diagram of the stop history data accumulation system in accordance with a second embodiment of the present invention;

FIG. 8 is a flowchart showing passed route information acquisition processing in accordance with the second embodiment of the present invention;

FIG. 9 is a flowchart showing the stop history accumulation processing in accordance with the second embodiment of the present invention;

FIG. 10 is a schematic drawing showing a data structure of the stop history database in accordance with the second embodiment of the present invention;

FIG. 11 is a schematic drawing showing an example of the first stop position and the second stop position in accordance with the second embodiment of the present invention;

FIG. 12 is a schematic drawing showing an example of the first stop position and the second stop position in accordance with the second embodiment of the present invention; and

FIGS. 13A and 13B are schematic drawings showing a structure of the stop history database.

### BEST MODE FOR CARRYING OUT THE INVENTION

Hereinafter, a first embodiment of the present invention will be described in the following order.

(1) Structure of Stop History Data Accumulation System

(1-1) Structure of Navigation Device

(1-2) Structure of Road Information Management Device

(2) Stop History Acquisition Processing and Stop History Accumulation Processing

(3) Usage Example of Stop History Database

(4) Other Embodiments in accordance with the First Embodiment

### (1) Structure of Stop History Data Accumulation System

(1-1) Structure of Navigation Device

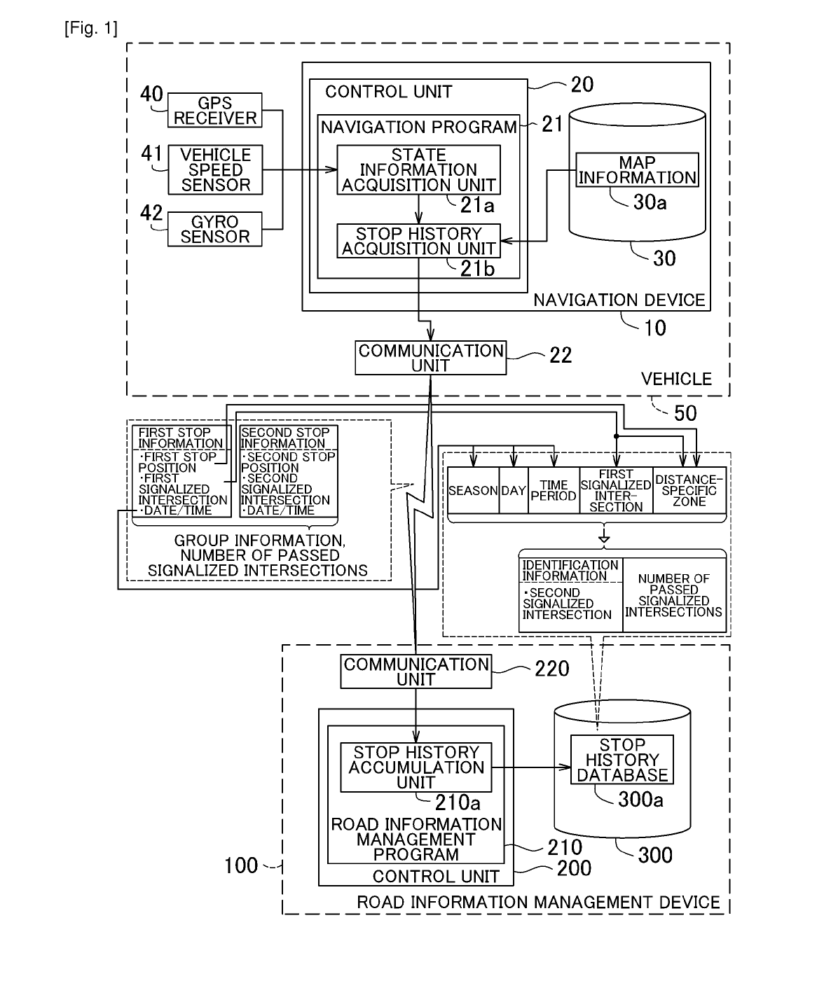

FIG. 1 is a block diagram showing the structure of a stop history data accumulation system that includes a navigation device 10 provided in a vehicle 50 and a road information management device 100 installed in a control center for road information. The navigation device 10 is mounted in the vehicle 50 that travels on a road. The navigation device 10 includes a control unit 20 equipped with a CPU, a RAM, a ROM, and the like, and also includes a storage medium 30. Programs stored in the storage medium 30 and the ROM can be executed by the control unit 20. In the first embodiment, a navigation program 21 can be executed as one such program, wherein a stop history of the vehicle 50 is collected by the navigation program 21 and sent to the road information management device 100.

For this reason, the vehicle 50 is provided with a GPS receiver 40, a vehicle speed sensor 41, and a gyro sensor 42. The GPS receiver 40 receives radio waves from a GPS satellite and outputs a signal for calculating a current position of the vehicle 50 and a signal specifying a current date and time via an interface (not shown). The control unit 20 acquires these signals to obtain the current position of the vehicle 50 and the date and time. The vehicle speed sensor 41 outputs a signal that corresponds to a rotational speed of a wheel provided in the vehicle 50. The control unit 20 acquires this signal via an interface (not shown) to obtain information on the speed of the vehicle 50. The gyro sensor 42 detects an angular acceleration when the vehicle 50 turns within a horizontal plane and outputs a signal that corresponds to the orientation of the vehicle 50. The control unit 20 acquires this signal via an interface (not shown) to obtain the travel direction of the vehicle 50. The vehicle speed sensor 41 and the gyro sensor 42 are utilized for correcting the current position of the vehicle 50 as identified from the output signal of the GPS receiver 40, and the like. In addition, the current position of the vehicle 50 is corrected as appropriate based on verification with map information 30a described later.

The navigation program 21 includes a state information acquisition unit 21a, a stop history acquisition unit 21b, and a communication control unit (not shown), and works in cooperation with a communication unit 22, the storage medium 30, the RAM in the control unit 20, and the like. In addition, the storage medium 30 stores the map information 30a for carrying out the above-described function performed by the navigation program 21. The map information 30a includes node data indicating nodes set on roads traveled by vehicles, shape interpolating data for identifying the shape of a road between nodes, link data indicating connections between nodes, and data indicating landmark objects existing on or around a road. The map information 30a is used for identifying the current position of the vehicle 50, performing a route search to a destination, performing route guidance to the destination, and the like.

The state information acquisition unit 21a is a module that realizes in the control unit 20 a function for obtaining information that indicates an state of the vehicle 50. The state information includes at least information specifying the current position of the vehicle and information for determining whether the vehicle has stopped. In the first embodiment, the current position of the vehicle and the vehicle speed are obtained based on information acquired from the GPS receiver 40, the vehicle speed sensor 41, and the gyro sensor 42.

The stop history acquisition unit 21b is a module that realizes in the control unit 20 a function for obtaining, based on the state information, group information formed from first stop information that includes a first stop position at which the vehicle stopped, and second stop information that includes a second stop position at which the vehicle stopped next after the first stop position. Regarding the first stop position and the second stop position here, for two consecutive stops made among a plurality of stops, the first stop position refers to a stop position that corresponds to a former stop in a time series, while the second stop position refers to a stop position that corresponds to a latter stop in the time series. The first stop information is information that includes at least the first stop position, and the second stop information is information that includes at least the second stop position. The first stop information and the second stop information corresponding to the two consecutive stops made are called one set of group information here. Furthermore, in the first embodiment, the stop history acquisition unit 21b also has a function for obtaining information that specifies a passed signalized intersection that the vehicle 50 passed through without stopping between the first stop position and the second stop position.

Note here that, as to whether the vehicle has stopped, the vehicle speed falling to or below a certain constant speed may be treated as the vehicle being stopped, and in the first embodiment, the vehicle is considered stopped when the following conditions are met. Specifically, once the vehicle speed falls to or below a certain first speed and a state in which the vehicle speed is smaller than a second speed that is greater than the first speed continues for a predetermined time or longer, then the vehicle is considered stopped. Note that the second speed is set approximately to a vehicle speed that is slightly greater than a vehicle speed at which a vehicle mounted with an automatic transmission travels during creeping, i.e., a vehicle speed when transitioning from not depressing to starting to depress an accelerator pedal.

The vehicle 50 is provided with the communication unit 22 structured from a circuit for communicating with the road information management device 100. Through processing of a communication control unit (not shown), the control unit 20 is capable of sending the aforementioned group information, a number of passed signalized intersections and other information via the communication unit 22 to the road information management device 100.

(1-2) Structure of Road Information Management Device

The road information management device 100 includes a control unit 200 that has a CPU, a RAM, a ROM, and the like, and a storage medium 300. The road information management device 100 is capable of executing a program stored in the storage medium 300 and the ROM using the control unit 200. In the first embodiment, a road information management program 210 can be executed as one such program and is provided with a stop history accumulation function as one function thereof.

The road information management device 100 receives information output by a plurality of the vehicles 50. To this end, the road information management device 100 is provided with a communication unit 220 structured from a circuit for communicating with the navigation device 10. Through processing of a communication control unit (not shown), the control unit 20 is capable of receiving information sent from the vehicle 50 via the communication unit 220.

The road information management program 210 is provided with the aforementioned communication control unit and a stop history accumulation unit 210a for receiving sent information from the vehicle 50 and for accumulating such information in the storage medium 300. The stop history accumulation unit 210a is a module that realizes in the control unit 200 a function for associating identification information, which is used to identify a road zone that includes the second stop position, with the first stop position based on information sent from the vehicle 50, and accumulating such associated information. Identification information associated with the first stop position is accumulated in a stop history database 300a of the storage medium 300 through stop history accumulation processing described later.

The above description involved the structure of the stop history data accumulation system.

### (2) Stop History Acquisition Processing and Stop History Accumulation Processing

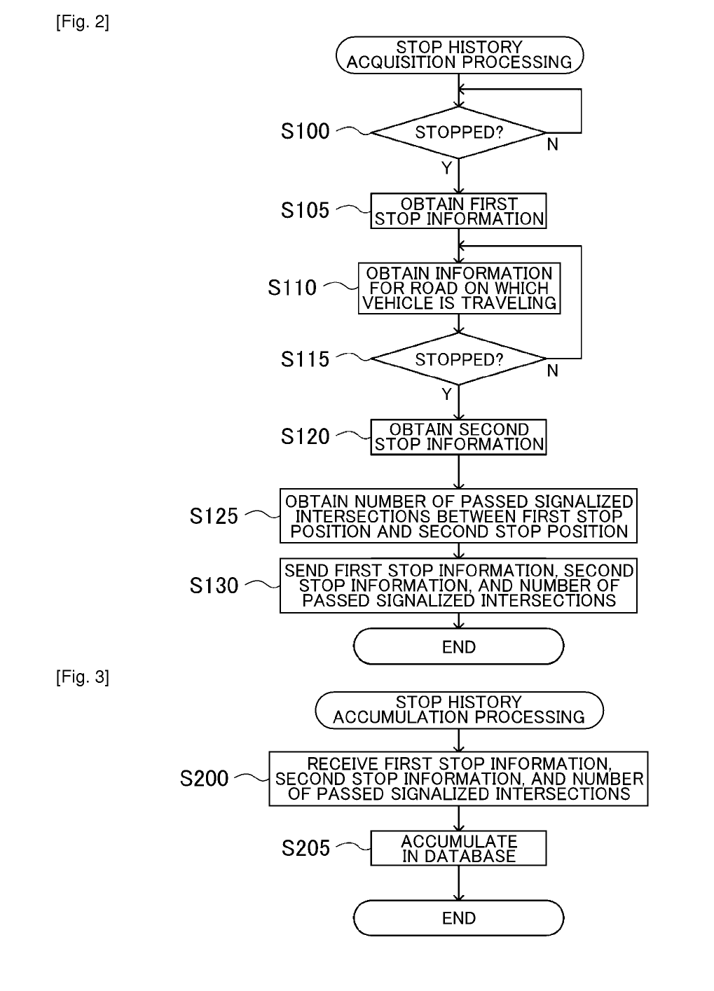

Next, stop history acquisition processing and stop history accumulation processing executed in the above structure will be explained. FIG. 2 is a flowchart showing the stop history acquisition processing performed on the navigation device 10 side. This processing is executed by the control unit 20 performing the processing of the above-described stop history acquisition unit 21b. In the first embodiment, a collection-target road zone in which a stop history is collected is determined in advance, and it is assumed that the vehicle 50 is traveling on the collection-target road zone.

First, based on the state information of the vehicle 50 as obtained by the state information acquisition unit 21a, the control unit 20 determines whether the vehicle 50 is stopped (step S100). Specifically, the control unit 20 measures a time spanning how long the current vehicle speed of the vehicle does not exceed the second speed after falling below the first speed based on the state information, and determines whether the time is equal to or greater than a predetermined number of seconds. If it is determined at step S100 that the vehicle is stopped, then the control unit 20 obtains the first stop information (step S105). In other words, the current position of the vehicle 50 at this time corresponds to the first stop position. The control unit 20 temporarily stores the current position of the vehicle 50 in the RAM as the first stop position, and also stores the date and time at such time in the RAM as well. In addition, the control unit 20 refers to the map information 30a to obtain information that specifies a signalized intersection ahead of the vehicle 50 at the first stop position, namely, a signalized intersection (a first signalized intersection) nearest to the vehicle 50, and temporarily stores such information in the RAM. The information specifying the first signalized intersection is not limited provided that the information is capable of identifying the first signalized intersection. For example, a node identifier corresponding to the signalized intersection, a position of the signalized intersection, and the like are conceivable.

Next, the control unit 20 obtains passed route information on a road the vehicle 50 travels after leaving the first stop position through the processing of the state information acquisition unit 21a (step S110), and determines whether the vehicle 50 is stopped (step S115). The processing at step S110 is repeatedly performed until the vehicle 50 stops. More specifically, for example, each time the vehicle 50 passes through a signalized intersection without stopping, information specifying the signalized intersection through which the vehicle 50 passed (a passed signalized intersection) is temporarily stored in the RAM. The stored information specifying the passed signalized intersection may be an identifier of the intersection, a position of the intersection, for example. At step S115, as explained above, it is determined whether a predetermined number of seconds has passed since the current vehicle speed of the vehicle 50 fell below the first speed.

If it is determined at step S115 that the vehicle 50 is stopped, then the control unit 20 obtains the second stop information (step S120). In other words, the current position of the vehicle 50 at this time corresponds to the second stop position. The control unit 20 temporarily stores the current position of the vehicle 50 in the RAM as the second stop position, and also stores the date and time at which the vehicle 50 stopped at the second stop position in the RAM as well. In addition, the control unit 20 refers to the map information 30a to obtain information that specifies a signalized intersection ahead of the vehicle 50 at the second stop position, namely, a signalized intersection (a second signalized intersection) nearest to the vehicle 50, and temporarily stores such information in the RAM. The information specifying the second signalized intersection is also not limited provided that the information is capable of identifying the second signalized intersection. For example, a node identifier corresponding to the signalized intersection, a position of the signalized intersection, and the like are conceivable.

The control unit 20 next obtains a number of passed signalized intersections between the first stop position and the second stop position (step S125). Specifically, the control unit 20 obtains the quantity of information specifying a passed signalized intersection that was stored in the RAM at step S110, and stores the quantity in the RAM. Next, the control unit 20 sends the one set of group information and the number of passed signalized intersections between the first stop position and the second stop position, which corresponds to the group information, to the road information management device 100 via the communication unit 22 (step S130), and ends the stop history acquisition processing.

Note that once it is determined at step S115 that the vehicle 50 is stopped, then the processing at step S120 onward is executed concurrently with the processing from step S105. By performing the stop history acquisition processing on the navigation device side in parallel in this manner, the second stop information structuring a certain set of group information serves as the first stop information for a subsequent set of group information. In other words, this means that the second stop position of a certain set also corresponds to the first stop position of a subsequent set. Therefore, it is possible to obtain all group information with regard to multiple stops in the collection-target road zone and the number of passed signalized intersections corresponding to the sets.

The aforementioned group information and the number of passed signalized intersections are sent to the control center from a plurality of vehicles installed with the navigation device executing the same processing above.

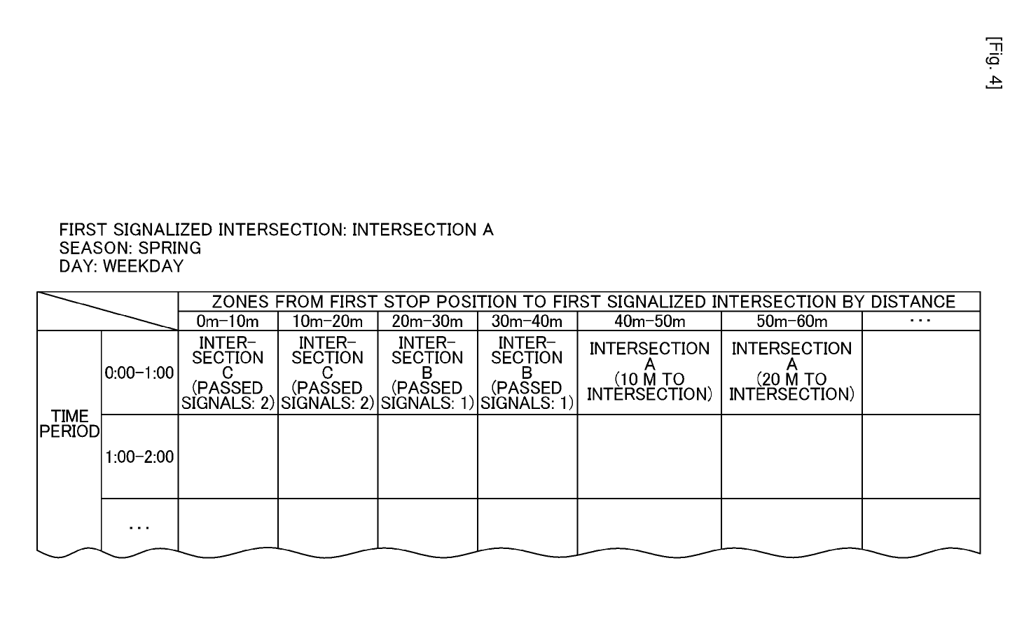

FIG. 3 shows the stop history accumulation processing performed on the road information management device 100 side. This processing is executed by the processing of the stop history accumulation unit 210a. In addition, this processing is activated each time communication is initiated from the vehicle 50. The control unit 20 receives one set of group information and the number of passed signalized intersections corresponding to the group information sent from the vehicle 50 via the communication unit 220 through the processing of the communication control unit (step S200). Based on the received information, the control unit 20 associates the identification information for identifying the road zone including the second stop position with the first stop position and information specifying the first signalized intersection, which are then accumulated in the stop history database 300a (step S205).

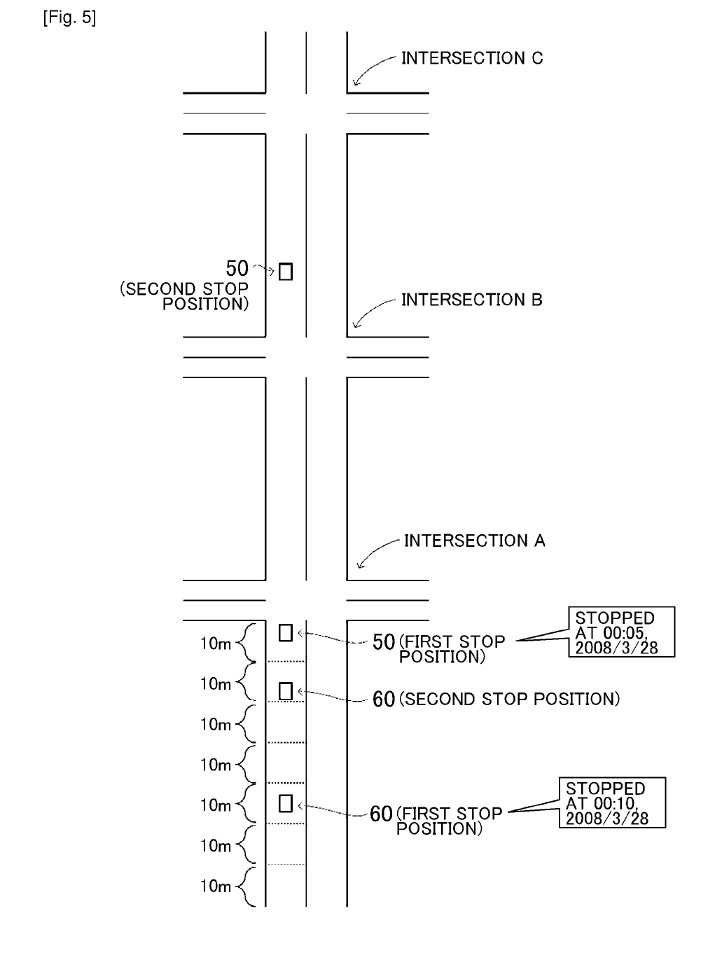

Using FIGS. 4 and 5, a specific example will be described regarding the accumulation of information in the stop history database 300a when the stop history acquisition processing and the stop history accumulation processing are performed. FIG. 4 shows an example of the structure of data accumulated in the stop history database 300a after information has been sent from the plurality of vehicles 50 to the road information management device 100 of the control center. In the first embodiment, a distance to the first signalized intersection is divided into units of 10-meter zones (distance-specific zones), and identification information is associated with the zone including the first stop position and accumulated. Therefore, the control unit 20 derives a distance from the first stop position to the first signalized intersection based on the received group information. The identification information is information capable of identifying a road zone that includes the second stop position based on the information, and in the first embodiment, an identifier of the second signalized intersection is accumulated as the identification information. Other conceivable information that may be used as the identification information includes, for example, the location (coordinates) of the second stop position itself, information specifying a link that includes the second stop position, and information specifying nodes that are start and finish points of the link. Furthermore, information specifying nodes that are start and finish points of a road zone (a zone forming two or more links) whose two end points are signalized intersections and which includes the second stop position may be used.

FIG. 5 shows that the vehicle 50 stopped at 12:05 AM on Friday, Mar. 28, 2008 in a zone less than 10 meters from a signalized intersection A, and then subsequently stopped between a signalized intersection B and a signalized intersection C. In such case, as shown in FIG. 4, an identifier specifying the signalized intersection C as the identification information is associated with the following and accumulated: first signalized intersection=A, season=spring; day=weekday; time period=0:00 to 1:00; distance from first stop position to first signalized intersection=0 to 10 meters. Additionally, the number of passed signalized intersections is associated with the first stop position and accumulated in the stop history database 300a. A number indicated by “(passed signals: XX)” in FIG. 4 refers to the number of passed signalized intersections. “(Passed signals: 2)” indicates that after stopping in front of the signalized intersection A, the vehicle 50 passed the two signalized intersections A and B after starting travel again.

In this manner, information specifying the second signalized intersection and serving as the identification information is associated with the date and time at which the vehicle 50 stopped at the first stop position, the first signalized intersection, and the distance-specific zone from the first signalized intersection to the first stop position, and then accumulated. Therefore, by referring to the stop history database, it is possible to identify which signal causes the vehicle to stop after the vehicle stops due to a certain signal within the collection-target zone at a certain date and time. In addition, since the number of passed signalized intersections is also accumulated, it is possible to identify what number the signalized intersection is that caused a subsequent stop of the vehicle after the vehicle stopped due to a certain signal. Note that, based on the received group information, a distance from the second signalized intersection to the second stop position may also be derived, and the second signalized intersection and the number of passed signalized intersections also accumulated.

For example, FIG. 5 also shows that a vehicle 60 mounted with the same navigation device as the vehicle 50 stopped at 12:10 AM on the same day in a zone at least 40 meters and less than 50 meters from the signalized intersection A, and then subsequently stopped in a zone at least 10 meters and less than 20 meters from the signalized intersection A. In such case, similar to the previous example, an identifier specifying the signalized intersection A is associated with the following and accumulated: first signalized intersection=A, season=spring; day=weekday; time period=0:00 to 1:00; distance from first stop position to first signalized intersection=40 to 50 meters. Since the first signalized intersection an the second signalized intersection are the same in this case, the number of passed signalized intersections is zero, and the distance to the second signalized intersection (signalized intersection A) is accumulated.

Note that in the first embodiment, when a plurality of sets of group information is obtained in which the first stop position is a predetermined position, representative identification information among the identification information for the respective sets of group information may be associated with the predetermined position and accumulated. In such case, after collecting the multiple sets of group information, statistical processing is used to derive representative identification information therefrom. The derived representative identification information can then be associated with the first stop position and accumulated. As a consequence, when a vehicle stops at a predetermined position, it is possible to estimate a position where the vehicle is highly likely to stop next by referring to such accumulated information. Here, a mean value, a mode value, a median value or the like may be assumed as the representative identification information, for example.

### (3) Usage Example of Stop History Database

As explained above, the stop history database 300a can be used for the purpose of estimating at which subsequent position there is a high likelihood of the vehicle stopping, i.e., estimating at which subsequent signalized intersection there is a high likelihood of the vehicle stopping in the first embodiment. For example, the stop history database 300a can be distributed to the navigation device and used for route guidance by the navigation device. More specifically, for example, when a vehicle mounted with the navigation device (in a case where the collection-target road zone is included in route guidance) stops at the signalized intersection A within the collection-target road zone, the stop history data may be referenced and voice guidance performed regarding the name of a subsequent signalized intersection where the vehicle is highly likely to stop, or voice guidance performed regarding a high possibility of the vehicle stopping at a subsequent nth (number of passed signalized intersections+1) signal. Also, the signalized intersection may be highlighted on a map shown in a display of the navigation device. Note that in a dynamic route search, when the vehicle is stopped at a certain position, a passage cost of passed signalized intersections up to a subsequent signalized intersection where there is a high likelihood of stopping may be set to zero. In addition, in cases where there is a high likelihood of stopping twice at the same signalized intersection, the passage cost of the signalized intersection may be set to double the passage cost of an ordinary signalized intersection.

### (4) Other Embodiments in Accordance with the First Embodiment

The above first embodiment is merely one example for carrying out the present invention. Various other embodiments can be adopted provided that based on state information indicating an state of the vehicle, group information is obtained that is formed from first stop information including a first stop position at which the vehicle stopped and formed from second stop information including a second stop position at which the vehicle stopped subsequent to the first stop position; and also provided that based on the group information, identification information for identifying a road zone including the second stop position is associated with the first stop position and accumulated.

In the above first embodiment, a structure was described in which a plurality of vehicles 50 send a collected stop history to the control center, and the road information management device 100 of the control center accumulates the stop history. However, a structure in which the acquisition of the state information, acquisition of the stop history, and accumulation of the stop history are completed on the vehicle 50 side may also be used, for example. In addition, a structure may be employed where the state information sent from the vehicle 50 side is received on the road information management device 100 side (the acquisition of the state information is performed), and the acquisition of the stop history and accumulation of the stop history are then performed on the road information management device 100 side. Also, the distance from the first signalized intersection to the first stop position and the distance from the second signalized intersection to the second stop position may be derived on the vehicle 50 side and sent to the control center.

Furthermore, in the above first embodiment, a structure was described in which information specifying the second signalized intersection is associated with the first stop position and information specifying the first signalized intersection, and accumulated. However, the second stop position may simply be associated with the first stop position and accumulated. According to this structure, the accumulated information can be referenced to identify a second stop position where the vehicle is likely to stop next after stopping at the first stop position. Moreover, information specifying the second signalized intersection may be associated with the first stop position and accumulated. According to this structure, information specifying the nearest signalized intersection in front of the second stop position, based on the travel direction of the vehicle, can be associated with the first stop position and accumulated. Therefore, after the vehicle stops at a certain position, it is possible to identify where the vehicle will stop next due to which signal, by referring to such associated and accumulated information.

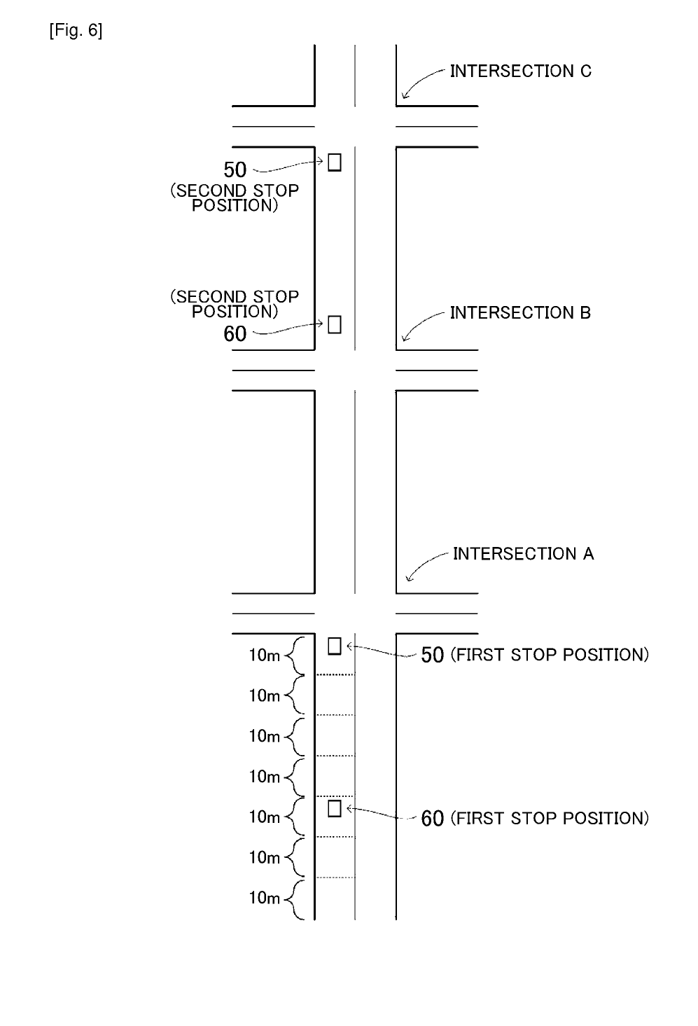

Also, when common identification information is respectively associated with two different first stop positions in a stop history accumulation unit, the common identification information may be associated with respective positions between the two different first stop positions and accumulated. For example, as illustrated in FIG. 6, information indicating the vehicle stopped in a zone at least 0 to under 10 meters from the signalized intersection A and next stopped between the signalized intersection B and the signalized intersection C is received from the vehicle 50. During the same time period, information indicating the vehicle stopped in a zone at least 40 to under 50 meters from the signalized intersection A and next stopped between the signalized intersection B and the signalized intersection C is received from the vehicle 60. In such case, the signalized intersection C may be similarly associated as the second signalized intersection with the zones at least 10 and under 20 meters, at least 20 and under 30 meters, and at least 30 and under 40 meters to the signalized intersection A, and stored. Thus, even if group information sent from vehicles cannot be sufficiently collected with respect to a section for which the accumulation of a stop history is desired, it is possible to interpolate as explained above and accumulate equally reliable information. Furthermore, in the above first embodiment, an example was described in which a signalized intersection was used as a stop-inducing object; however, a railroad crossing signal may also be utilized as the stop-inducing object.

Hereinafter, a second embodiment of the present invention will be described in the following order.

### (1) Structure of Stop History Data Accumulation System

### (1-1) Structure of Navigation Device

### (1-2) Structure of Road Information Management Device

### (2) Passed Route Information Acquisition Processing and Stop History Accumulation Processing

### (3) Usage Example of Stop History Database

(4) Other Embodiments in accordance with the Second Embodiment

### (1) Structure of Stop History Data Accumulation System

(1-1) Structure of Navigation Device

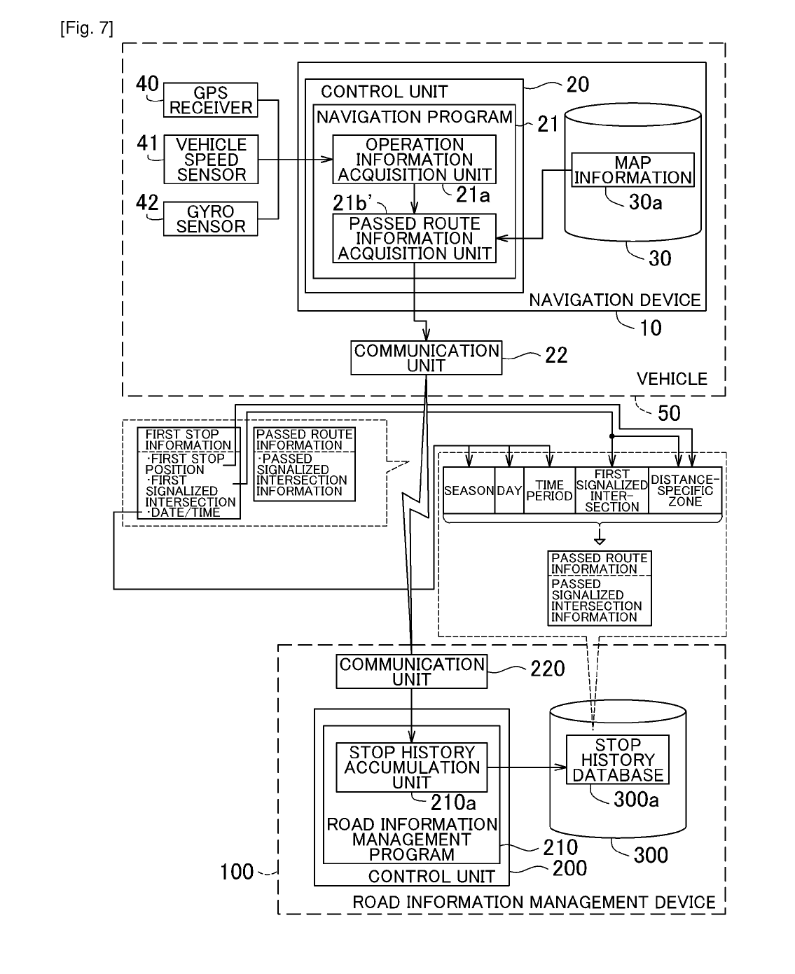

FIG. 7 is a block diagram showing the structure of a stop history data accumulation system that includes a navigation device 10 provided in a vehicle 50 and a road information management device 100 installed in a control center for road information. The navigation device 10 is mounted in the vehicle 50 that travels on a road. The navigation device 10 includes a control unit 20 equipped with a CPU, a RAM, a ROM, and the like, and also includes a storage medium 30. Programs stored in the storage medium 30 and the ROM can be executed by the control unit 20. In the second embodiment, a navigation program 21 can be executed as one such program, wherein a stop position, a passed route information and the like of the vehicle 50 are collected by the navigation program 21 and sent to the road information management device 100.

For this reason, the vehicle 50 is provided with a GPS receiver 40, a vehicle speed sensor 41, and a gyro sensor 42. The GPS receiver 40 receives radio waves from a GPS satellite and outputs a signal for calculating a current position of the vehicle 50 and a signal specifying a current date and time via an interface (not shown). The control unit 20 acquires these signals to obtain the current position of the vehicle 50 and the date and time. The vehicle speed sensor 41 outputs a signal that corresponds to a rotational speed of a wheel provided in the vehicle 50. The control unit 20 acquires this signal via an interface (not shown) to obtain information on the speed of the vehicle 50. The gyro sensor 42 detects an angular acceleration when the vehicle 50 turns within a horizontal plane and outputs a signal that corresponds to the orientation of the vehicle 50. The control unit 20 acquires this signal via an interface (not shown) to obtain the travel direction of the vehicle 50. The vehicle speed sensor 41 and the gyro sensor 42 are utilized for correcting the current position of the vehicle 50 as identified from the output signal of the GPS receiver 40, and the like. In addition, the current position of the vehicle 50 is corrected as appropriate based on verification with map information 30a described later.

The navigation program 21 includes a state information acquisition unit 21a, a passed route information acquisition unit 21b′, and a communication control unit (not shown), and works in cooperation with a communication unit 22, the storage medium 30, the RAM in the control unit 20, and the like. In addition, the storage medium 30 stores the map information 30a for carrying out the above-described function performed by the navigation program 21. The map information 30a includes node data indicating nodes set on roads traveled by vehicles, shape interpolating data for identifying the shape of a road between nodes, link data indicating connections between nodes, and data indicating landmark objects existing on or around a road. The map information 30a is used for identifying the current position of the vehicle 50, performing a route search to a destination, performing route guidance to the destination, and the like.

The state information acquisition unit 21a is a module that realizes in the control unit 20 a function for obtaining information that indicates an state of the vehicle 50. The state information includes at least information specifying the current position of the vehicle and information for determining whether the vehicle has stopped. In the second embodiment, the current position of the vehicle, the vehicle speed, and the travel direction are obtained based on information acquired from the GPS receiver 40, the vehicle speed sensor 41, and the gyro sensor 42.

The passed route information acquisition unit 21b' is a module that realizes in the control unit 20 a function for obtaining, based on the state information obtained by the state information acquisition unit 21a, first stop information that includes a first stop position at which the vehicle 50 stopped, and passed route information specifying a route from the first stop position to a second stop position at which the vehicle stopped next after the first stop position. Regarding the first stop position and the second stop position here, for two consecutive stops made among a plurality of stops, the first stop position refers to a stop position that corresponds to a former stop in a time series, while the second stop position refers to a stop position that corresponds to a latter stop. The first stop information is information that includes at least the first stop position. The second stop information is information that includes at least the second stop position. The passed route information is not limited provided that the information is capable of identifying the route that the vehicle traveled between the first stop position and the second stop position. It may be information that relatively specifies the route that the vehicle traveled using the first stop position as a reference. Or, it may be information in which identifiers of passed nodes and links are listed in the passed order. In the second embodiment, the passed route information includes the identifiers of signalized intersections through which the vehicle passed between the first stop position and the second stop position. If the vehicle passes not-signalized intersections, the passed route information may include the identifiers of the not-signalized intersections.

Note here that, as to whether the vehicle has stopped, the vehicle speed falling to or below a certain constant speed may be treated as the vehicle being stopped, and in the second embodiment, the vehicle is considered stopped when the following conditions are met. Specifically, once the vehicle speed falls to or below a certain first speed and a state in which the vehicle speed is smaller than a second speed that is greater than the first speed continues for a predetermined time or longer, then the vehicle is considered stopped. Note that the second speed is set approximately to a vehicle speed that is slightly greater than a vehicle speed at which a vehicle mounted with an automatic transmission travels during creeping, i.e., a vehicle speed when transitioning from not depressing to starting to depress an accelerator pedal.

The vehicle 50 is provided with the communication unit 22 structured from a circuit for communicating with the road information management device 100. Through processing of a communication control unit (not shown), the control unit 20 is capable of sending the aforementioned first stop information, the passed route information, and other information via the communication unit 22 to the road information management device 100.

(1-2) Structure of Road Information Management Device

The road information management device 100 includes a control unit 200 that has a CPU, a RAM, a ROM, and the like, and a storage medium 300. The road information management device 100 is capable of executing a program stored in the storage medium 300 and the ROM using the control unit 200. In the second embodiment, a road information management program 210 can be executed as one such program and is provided with a stop history accumulation function as one function thereof.

The road information management device 100 receives information output by a plurality of the vehicles 50. To this end, the road information management device 100 is provided with a communication unit 220 structured from a circuit for communicating with the navigation device 10. Through processing of a communication control unit (not shown), the control unit 20 is capable of receiving the first stop information, the passed route information, and other information sent from the vehicle 50 via the communication unit 220.

The road information management program 210 is provided with the aforementioned communication control unit and a stop history accumulation unit 210a for receiving sent information from the vehicle 50 and for accumulating such information in the storage medium 300. The stop history accumulation unit 210a is a module that realizes in the control unit 200 a function for associating the passed route information with the first stop position based on information such as the first stop information, the passed route information, and other information sent from the vehicle 50, and accumulating such associated information. The passed route information associated with the first stop position is accumulated in a stop history database 300a of the storage medium 300.

The above description involved the structure of the stop history data accumulation system.

### (2) Passed Route Information Acquisition Processing and Stop History Accumulation Processing

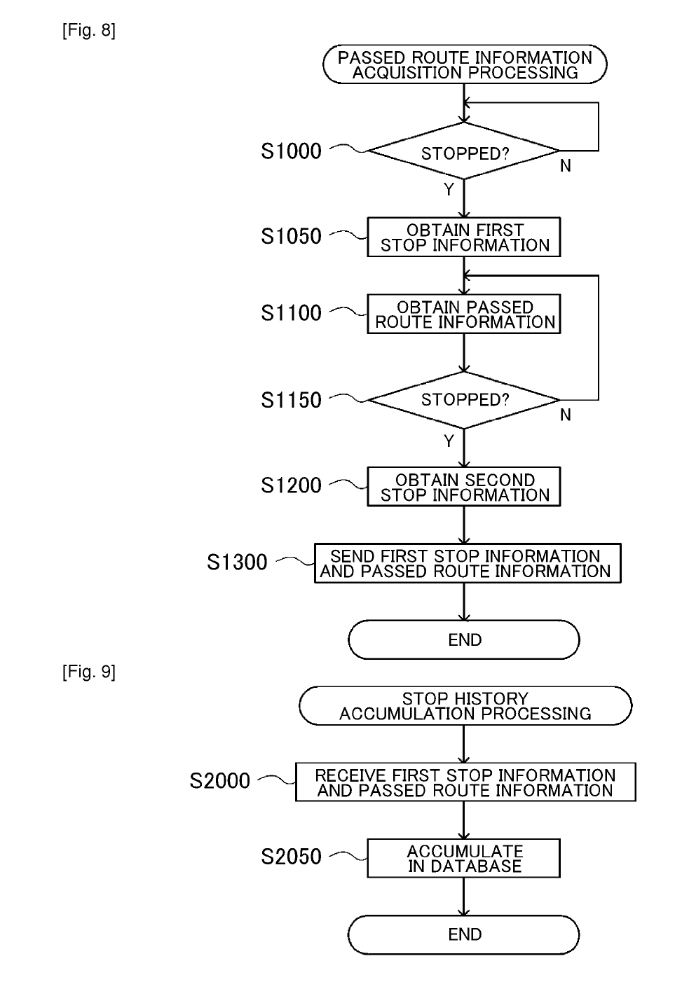

Next, passed route information acquisition processing and stop history accumulation processing executed in the above structure will be explained. FIG. 8 is a flowchart showing the passed route information acquisition processing performed on the navigation device 10 side. This processing is executed by the control unit 20 performing the processing of the above-described passed route information acquisition unit 21b′.

First, based on the state information of the vehicle 50 as obtained by the state information acquisition unit 21a, the control unit 20 determines whether the vehicle 50 is stopped (step S1000). Specifically, the control unit 20 measures a time spanning how long the current vehicle speed of the vehicle does not exceed the second speed after falling below the first speed based on the state information, and determines whether the time is equal to or greater than a predetermined number of seconds. If it is determined at step S1000 that the vehicle is stopped, then the control unit 20 obtains the first stop information (step S1050). In other words, the current position of the vehicle 50 at this time corresponds to the first stop position. The control unit 20 temporarily stores the current position of the vehicle 50 in the RAM as the first stop position, and also stores the date and time at such time in the RAM as well. In addition, the control unit 20 refers to the map information 30a to obtain information that specifies a signalized intersection ahead of the vehicle 50 at the first stop position, namely, a signalized intersection (a first signalized intersection) nearest to the vehicle 50, and temporarily stores such information in the RAM. The information specifying the first signalized intersection is not limited provided that the information is capable of identifying the first signalized intersection. For example, a node identifier corresponding to the signalized intersection, a position of the signalized intersection, and the like are conceivable.

Next, the control unit 20 obtains the passed route information specifying the route that the vehicle 50 traveled based on the information obtained by the processing of the state information acquisition unit 21a (step S1100), and determines whether the vehicle 50 is stopped (step S1150). The processing at step S1100 is repeatedly performed until the vehicle 50 stops. More specifically, for example, each time the vehicle 50 passes through a signalized intersection without stopping, information (passed signalized intersection information) specifying the signalized intersection through which the vehicle 50 passed (a passed signalized intersection) is temporarily stored in the RAM. The stored information specifying the passed signalized intersection may include an identifier specifying the signalized intersection, a position of the signalized intersection, a number of passed signalized intersections, for example. At step S1150, as explained above, it is determined whether a predetermined number of seconds has passed since the current vehicle speed of the vehicle 50 fell below the first speed.

If it is determined at step S1150 that the vehicle 50 is stopped, then the control unit 20 obtains the second stop information (step S1200). In other words, the current position of the vehicle 50 at this time corresponds to the second stop position. The control unit 20 temporarily stores the current position of the vehicle 50 in the RAM as the second stop position, and also stores the date and time at which the vehicle 50 stopped at the second stop position in the RAM as well. In addition, the control unit 20 refers to the map information 30a to obtain information that specifies a signalized intersection ahead of the vehicle 50 at the second stop position, namely, a signalized intersection (a second signalized intersection) nearest to the vehicle 50, and temporarily stores such information in the RAM. The information specifying the second signalized intersection is also not limited provided that the information is capable of identifying the second signalized intersection. For example, a node identifier corresponding to the signalized intersection, a position of the signalized intersection, and the like are conceivable.

Next, the control unit 20 sends the first stop information and the passed route information to the road information management device 100 via the communication unit 22 (step S1300), and ends the passed route information acquisition processing.

Note that once it is determined at step S1150 that the vehicle 50 is stopped, then the processing at step S1200 onward is executed concurrently with the processing from step S1050. By performing the passed route information acquisition processing in parallel in this manner, the second stop position of a certain set is regarded as the first stop position of a subsequent set. Therefore, each time the vehicle is stopped, it is possible to obtain the passed route information from such a stop to a subsequent stop.

The aforementioned first stop information and the passed route information are sent to the control center from a plurality of vehicles installed with the navigation device executing the same processing above.

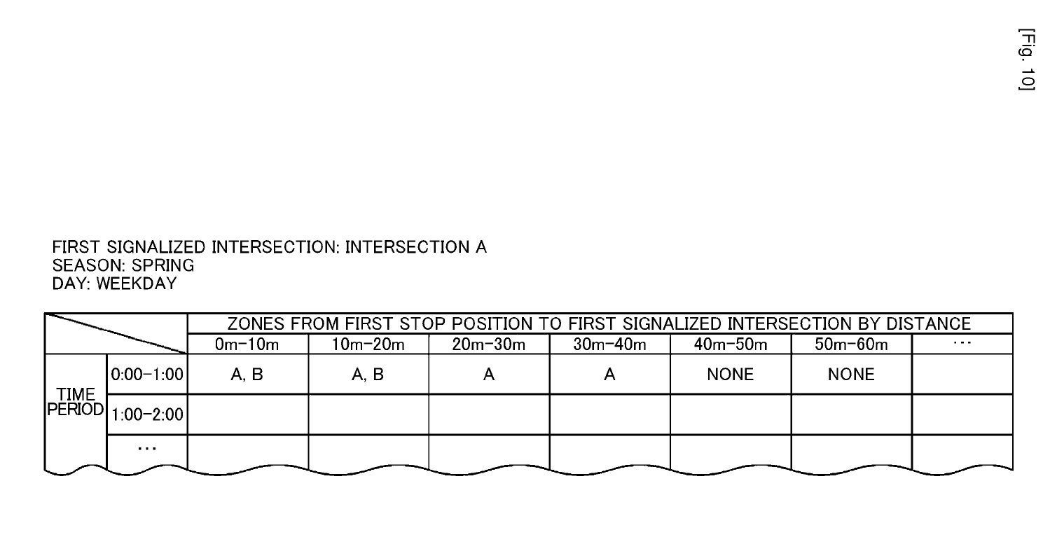

FIG. 9 shows the stop history accumulation processing performed on the road information management device 100 side. This processing is executed by the processing of the stop history accumulation unit 210a. In addition, this processing is activated each time communication is initiated from the vehicle 50. The control unit 20 receives the first stop information and the passed route information sent from the vehicle 50 via the communication unit 220 through the processing of the communication control unit (step S2000), and associates the passed route information specifying the route from the first stop position to the second stop position with the first stop position and information specifying the first signalized intersection, which are then accumulated in the stop history database 300a (step S2050).

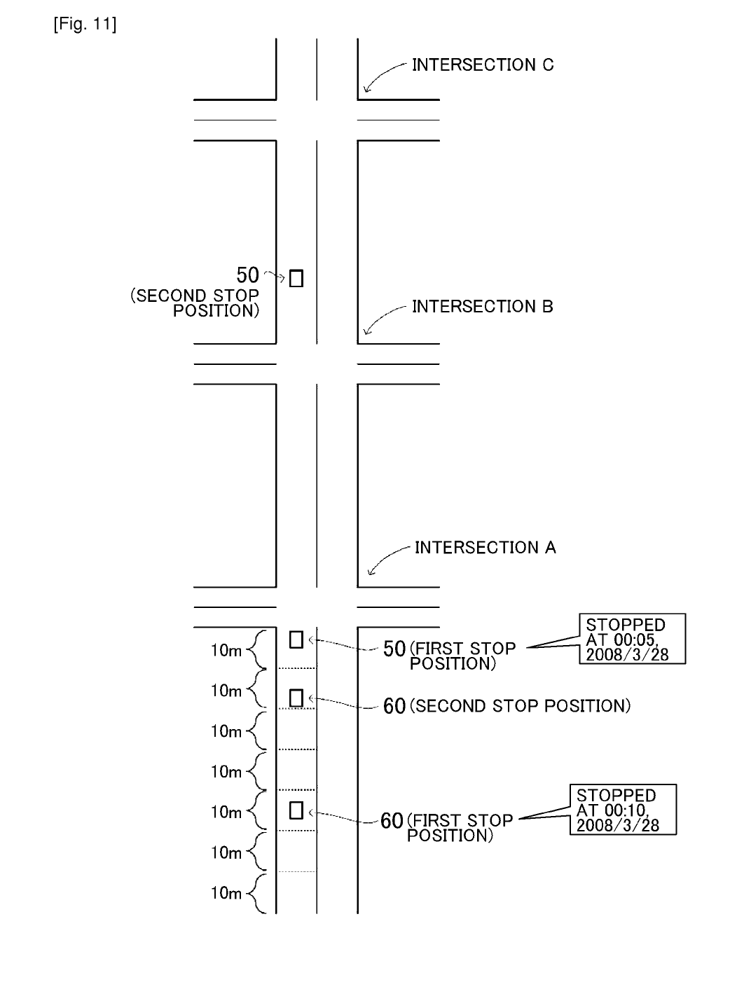

Using FIGS. 10 and 11, a specific example will be described regarding the accumulation of information in the stop history database 300a when the passed route information acquisition processing and the stop history accumulation processing are performed. FIG. 10 shows an example of the structure of data accumulated in the stop history database 300a after information has been sent from the plurality of vehicles 50 to the road information management device 100 of the control center. In the second embodiment, a distance to the first signalized intersection is divided into units of 10-meter zones (distance-specific zones), and the passed route information is associated with the zone including the first stop position and accumulated. Therefore, the control unit 20 derives a distance from the first stop position to the first signalized intersection based on the received first stop information.

FIG. 11 shows that the vehicle 50 stopped at 12:05 AM on Friday, Mar. 28, 2008 in a zone less than 10 meters from a signalized intersection A, and then subsequently stopped between a signalized intersection B and a signalized intersection C. In such case, as shown in FIG. 10, identifiers specifying the passed signalized intersection A and the passed signalized intersection B are associated with the following and accumulated: first signalized intersection=A, season=spring; day=weekday; time period=0:00 to 1:00; distance from first stop position to first signalized intersection=0 to 10 meters.

In this manner, the passed signalized intersection information serving as the passed route information is associated with the date and time at which the vehicle 50 stopped at the first stop position, the first signalized intersection, and the distance-specific zone from the first signalized intersection to the first stop position, and then accumulated. Therefore, by referring to the stop history database 300a, it is possible to identify, after the vehicle stopped at a certain point due to a certain signal at a certain date and time, which signalized intersection the vehicle passed through before a subsequent stop. That is, it is possible to identify, from the passed signalized intersection, the route that the vehicle traveled from the first stop position to the second stop position. When the passed signalized intersection has been identified, it is possible to assume that the signalized intersection next after the finally-passed signalized intersection caused the vehicle to stop. Note that, if the vehicle passed a not-signalized intersection between the first stop position and the second stop position, information specifying the not-signalized intersection may be accumulated in the same manner.

For example, a vehicle 60 mounted with the same navigation device as the vehicle 50 stopped at 12:10 AM on the same day in a zone at least 40 meters and less than 50 meters from the signalized intersection A, and then subsequently stopped in a zone at least 10 meters and less than 20 meters from the signalized intersection A. In such case, there is no passed signalized intersection between the first stop position and the second stop position. Therefore, information indicating that there is no passed signalized intersection is associated with the following and accumulated: first signalized intersection=A, season=spring; day=weekday; time period=0:00 to 1:00; distance from first stop position to first signalized intersection=40 to 50 meters. Also, the distance from the first stop position to the second stop position may be accumulated.

Note that in the second embodiment, when a plurality of passed route information having one and the same position as the first stop position for the same period of time is obtained, the plurality of passed route information may be accumulated. Or, when a plurality of route information having one and the same position as the first stop position for the same period of time is obtained, statistical processing is used to derive representative passed route information therefrom. The derived representative passed route information can then be associated with the first stop position and accumulated. As a consequence, when a vehicle stops at a predetermined position, it is possible to estimate where is the position at which the vehicle is highly likely to stop next as a result of which route the vehicle travels, by referring to such accumulated information. Here, a mean value, a mode value, a median value or the like may be assumed as the representative passed route information, for example.

### (3) Usage Example of Stop History Database

As explained above, the stop history database 300a can be used for the purpose of estimating, after the vehicle stops at a certain point, which route there is a high likelihood of the vehicle traveling and then at which subsequent position there is a high likelihood of the vehicle stopping, i.e., estimating, when the vehicle stops due to a certain signalized intersection, which route there is a high likelihood of the vehicle subsequently traveling and then at which subsequent signalized intersection there is a high likelihood of the vehicle stopping in the second embodiment.

The stop history database 300a in which information is accumulated in this manner can be distributed to the navigation device and used for route guidance by the navigation device, for example. More specifically, for example, when a vehicle mounted with the navigation device stops at a point less than 10 meters from the signalized intersection A, the stop history database 300a may be referenced and it may be determined whether or not a guidance route after passing the signalized intersection A matches the route specified by the passed route information in which such a point is accumulated as the first stop position. If the guidance route matches the route specified by the passed route information, voice guidance may be performed regarding the name of a subsequent signalized intersection where the vehicle is highly likely to stop, or voice guidance may be performed regarding a high possibility of the vehicle stopping at a subsequent nth (number of passed signalized intersections+1) signal. Also, the signalized intersection may be highlighted on a map shown in a display of the navigation device. Note that in a dynamic route search, a passage cost of the passed signalized intersections may be set to zero. In addition, in cases where there is a high likelihood of stopping twice at the same signalized intersection, the passage cost of the signalized intersection may be set to double the passage cost of an ordinary signalized intersection.

### (4) Other Embodiments in Accordance with the Second Embodiment

The above second embodiment is merely one example for carrying out the present invention. Various other embodiments can be adopted provided that state information indicating an state of the vehicle is obtained, based on the state information, first stop information including a first stop position at which the vehicle stopped and passed route information specifying a route from the first stop position to a second stop position at which the vehicle stopped subsequent to the first stop position are obtained; and also provided that the passed route information is associated with the first stop position and accumulated.

In the above second embodiment, a structure was described in which a plurality of vehicles 50 send the collected first stop position information and passed route information to the control center, and the road information management device 100 of the control center associates the passed route information with the first stop position information and accumulates such information. However, a structure in which the acquisition of the state information, acquisition of the passed route information, and acquisition of the stop history are completed on the vehicle 50 side may also be used, for example. In addition, a structure may be employed where the state information sent from the vehicle 50 side is received on the road information management device 100 side (the acquisition of the state information is performed), and the acquisition of the passed route information and accumulation of the stop history are then performed on the road information management device 100 side. Also, the distance from the first signalized intersection to the first stop position and the distance from the second signalized intersection to the second stop position may be derived on the vehicle 50 side and sent to the control center. In such case, the distance from the second signalized intersection to the second stop position as well as the passed signalized intersection information may be associated with the first signalized intersection and the distance from the first signalized intersection to the first stop position, and accumulated.

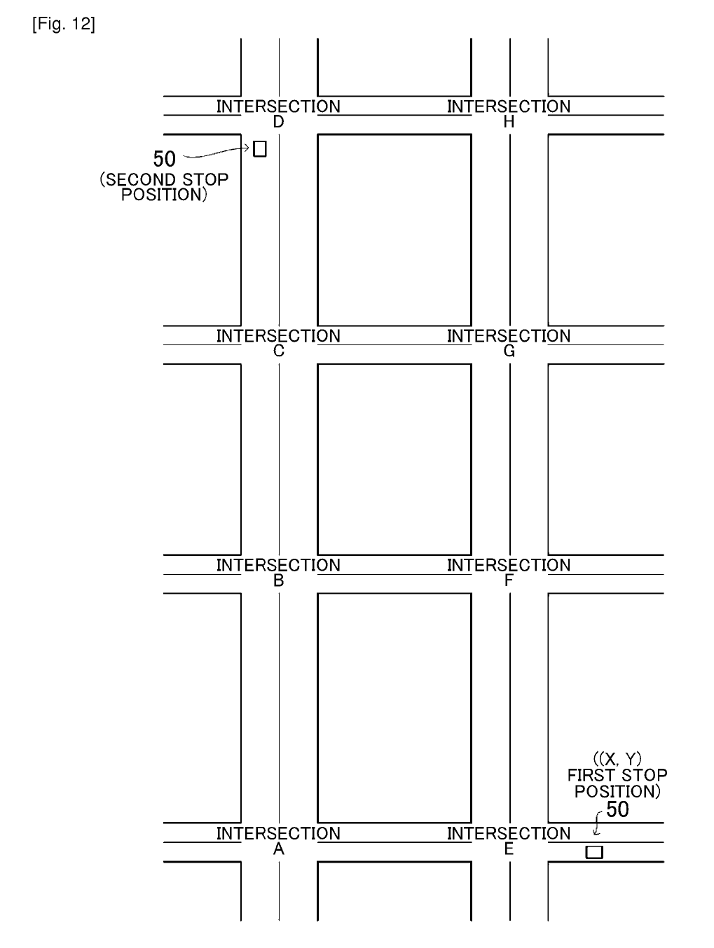

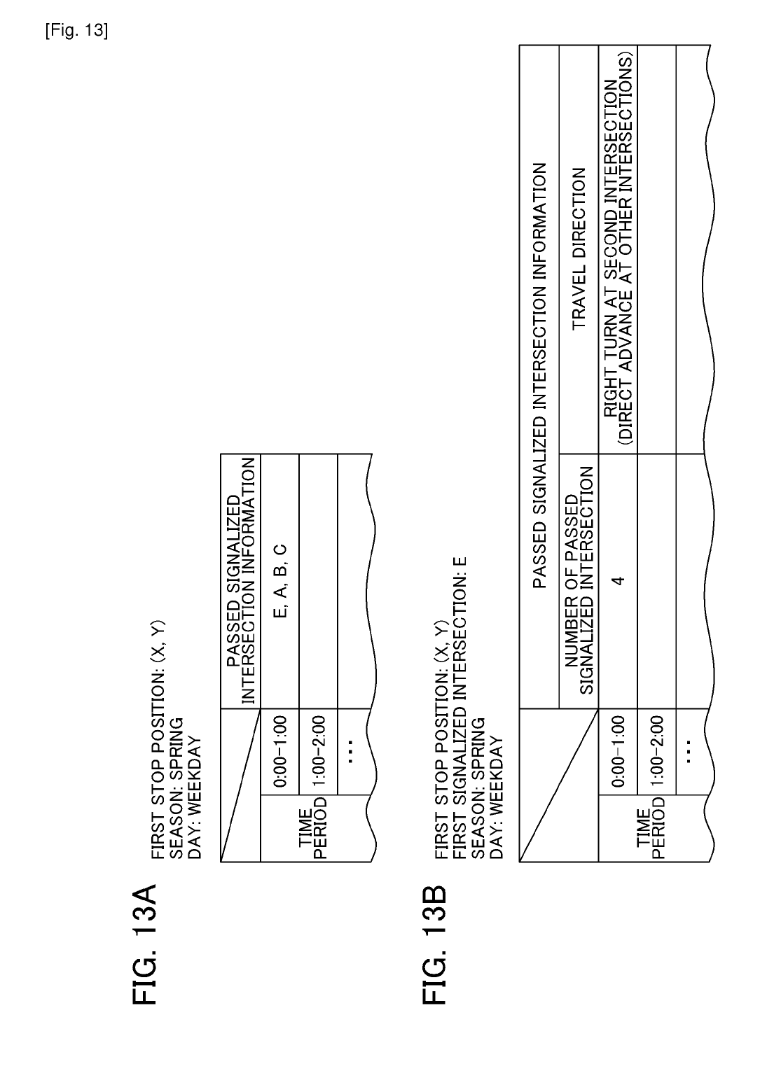

Also, in the above second embodiment, a structure was described in which the passed route information is associated with the distance-specific zone from the first signalized intersection to the first stop position, and then accumulated. However, a structure in which the passed route information is associated with the first stop position itself and accumulated may also be used, for example. As illustrated in FIG. 12, for example, after the vehicle stopped at a point (X, Y), if the vehicle passed signalized intersections E, A, B, and C in this order and stopped at a point between a signalized intersection C and a signalized intersection D, as illustrated in FIG. 13A, identifiers specifying the passed signalized intersections (E, A, B, and C) may be associated with the first stop position (X, Y) and accumulated.

Also, the passed route information relatively specifying a passed route using the first stop position as reference may be associated with the first stop position and the first signalized intersection and accumulated, for example. In the case of the example of FIG. 12, as illustrated in FIG. 13B, the number of passed signalized intersections (4) and the travel direction in which the vehicle traveled at the passed signalized intersections (right turn at the second intersection and direct advance at the other intersections) may be associated with the first stop position (X, Y) and the signalized intersection E and accumulated, for example. The stop history database in which information has been accumulated in this manner can be used for the purpose of estimating, when the vehicle stops at a certain point due to a certain signalized intersection, which route there is a high likelihood of the vehicle subsequently traveling and then at which subsequent signalized intersection there is a high likelihood of the vehicle stopping. Furthermore, in the above second embodiment, an example was described in which a signalized intersection was used as a stop-inducing object; however, a railroad crossing signal may also be utilized as the stop-inducing object.

1. A stop history data accumulation system comprising:
a state information acquisition unit that obtains state information indicating a state of a vehicle;
a stop history acquisition unit that, based on the state information, obtains group information that is formed from first stop information, including a first stop position at which the vehicle stopped and information specifying a first signalized intersection nearest to the vehicle that is ahead of the vehicle at the first stop position, and formed from second stop information, including a second stop position at which the vehicle stopped subsequent to the first stop position and information specifying a second signalized intersection nearest to the vehicle that is ahead of the vehicle at the second stop position; and
a stop history accumulation unit that, based on the group information, accumulates identification information which is the information specifying the second signalized intersection, by associating with the first stop position and the information specifying the first signalized intersection, the identification information being used for identifying a road zone including the second stop position, wherein
the identification information is associated with a distance between the first stop position and the first signalized intersection.

2-3. (canceled)

4. The stop history data accumulation system according to claim 1, wherein
the first stop information includes a date and time at which the vehicle stopped at the first stop position, and
the stop history accumulation unit further accumulates the identification information, by associating with a time period to which the date and time belong.

5. The stop history data accumulation system according to claim 1, wherein
the stop history acquisition unit obtains information specifying a passed signalized intersection that the vehicle passed without stopping between the first stop position and the second stop position, and
the stop history accumulation unit accumulates a number of passed signaled intersections, by associating with the first stop position.

6. The stop history data accumulation system according to claim 1, wherein
the stop history accumulation unit, when a plurality of sets of group information is obtained in which the first stop position is a predetermined position, accumulates representative identification information among the identification information for the respective sets of group information, by associating with the predetermined position.

7. A stop history data accumulation method comprising:
obtaining state information indicating a state of a vehicle;
based on the state information, obtaining group information that is formed from first stop information, including a first stop position at which the vehicle stopped and information specifying a first signalized intersection nearest to the vehicle that is ahead of the vehicle at the first stop position, and formed from second stop information, including a second stop position at which the vehicle stopped subsequent to the first stop position and information specifying a second signalized intersection nearest to the vehicle that is ahead of the vehicle at the second stop position; and
based on the group information, accumulating identification information which is the information specifying the second signalized intersection, by associating with the first stop position and the information specifying the first signalized intersection, the identification information being used for identifying a road zone including the second stop position, by associating with the first stop position, wherein
the identification information is associated with a distance between the first stop position and the first signalized intersection.

8. A non-transitive computer-readable storage medium storing a computer-executable stop history data accumulation program that causes a computer to execute the functions of:
obtaining state information indicating a state of a vehicle;
based on the state information, obtaining group information that is formed from first stop information, including a first stop position at which the vehicle stopped and information specifying a first signalized intersection nearest to the vehicle that is ahead of the vehicle at the first stop position, and formed from second stop information, including a second stop position at which the vehicle stopped subsequent to the first stop position and information specifying a second signalized intersection nearest to the vehicle that is ahead of the vehicle at the second stop position; and
based on the group information, accumulating identification information which is the information specifying the second signalized intersection, by associating with the first stop position and the information specifying the first signalized intersection, the identification information being used for identifying a road zone including the second stop position, by associating with the first stop position, characterized in that
the identification information is associated with a distance between the first stop position and the first signalized intersection.

9. The stop history data accumulation system according to claim 1, wherein
the stop history accumulation unit accumulates common identification information associated with respective positions between two different first stop positions, when the common identification information specifying the same second signalized intersection is respectively associated with the two different first stop positions.
